(19) United States
(12) Patent Application Publication
(10) Pub. No.: US 2016/0291804 A1
(43) Pub. Date: Oct. 6, 2016

(54) DISPLAY CONTROL METHOD AND DISPLAY CONTROL DEVICE

(71) Applicant: FUJITSU LIMITED, Kawasaki-shi (JP)

(72) Inventors: Keiju Okabayashi, Sagamihara (JP); Bin Chen, MACHIDA (JP); Yoshihiko MURAKAWA, Yokohama (JP); Yusuke Yasukawa, Yokohama (JP)

(73) Assignee: FUJITSU LIMITED, Kawasaki-shi (JP)

(21) Appl. No.: 15/085,667

(22) Filed: Mar. 30, 2016

(30) Foreign Application Priority Data
Apr. 3, 2015 (JP) 2015-076822

(51) Int. Cl. G06F 3/0481; G06F 3/0488

(52) U.S. Cl. CPC G06F 3/0481; G06F 3/04883

(57) ABSTRACT

A display control system includes a communication device and a display control device configured to communicate with the communication device, wherein the communication device includes first circuitry configured to detect a specific event, and transmit notification information on the specific event to the display control device, and wherein the display control device includes second circuitry configured to detect drawing processing performed by a user on a screen, determine a window frame on the screen according to the drawing processing, and perform control to display a content in the window frame when the notification information is received, the content being designated as a display object by the communication device that has transmitted the notification information.

### CROSS-REFERENCE TO RELATED APPLICATION

This application is based upon and claims the benefit of priority of the prior Japanese Patent Application No. 2015-076822, filed on Apr. 3, 2015, the entire contents of which are incorporated herein by reference.

### FIELD

The embodiments discussed herein are related to a technique that controls display of content.

### BACKGROUND

In a general window system, when a user designates the start of application (an application program, an application), a window is displayed at a predetermined position on a screen, and the content of the application is displayed. In addition, there are also techniques disclosed in Japanese Laid-open Patent Publication No. 2013-130915 and Japanese Laid-open Patent Publication No. 2001-5599.

### SUMMARY

According to an aspect of the invention, a display control system includes a communication device and a display control device configured to communicate with the communication device, wherein the communication device includes first circuitry configured to detect a specific event, and transmit notification information on the specific event to the display control device, and wherein the display control device includes second circuitry configured to detect drawing processing performed by a user on a screen, determine a window frame on the screen according to the drawing processing, and perform control to display a content in the window frame when the notification information is received, the content being designated as a display object by the communication device that has transmitted the notification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting an example configuration of a system according to an embodiment;

FIGS. 2A and 2B are each an illustration depicting an example configuration of a display;

FIG. 3 is a diagram depicting an example configuration of an operation detection unit;

FIG. 4 is a flow chart depicting an overall processing example;

FIG. 5 is a flow chart of a first processing example of the operation detection unit;

FIGS. 6A, 6B, 6C and 6D are each an illustration depicting an operation example and a display example;

FIGS. 7A, 7B, and 7C are illustrations depicting a processing example of estimation of a window frame;

FIG. 8 is a flow chart of a second processing example of the operation detection unit;

FIG. 9 is an illustration depicting an example handwritten signature;

FIG. 10 is a flow chart of a third processing example of the operation detection unit;

FIGS. 11A, 11B, and 11C are each an illustration depicting an example change of display of a start circle;

FIG. 12 is a flow chart depicting a processing example of evaluation of a path and adjustment of the start circle;

FIGS. 13A, 13B, 13C, and 13D are illustrations depicting example symbols;

FIGS. 14A, 14B, and 14C depict an example calculation of a frame probability and the size of a start circle;

FIG. 15 is a flow chart of a fourth processing example of the operation detection unit;

FIGS. 16A, 16B, and 16C are illustrations depicting an example estimation and determination of a figure;

FIGS. 17A and 17B are each an illustration depicting a processing example of estimation of a figure;

FIG. 18 is a flow chart of a fifth processing example of the operation detection unit;

FIGS. 19A, 19B, and 19C are illustrations depicting an example estimation and determination of a figure;

FIG. 20 is a flow chart of a sixth processing example of the operation detection unit;

FIGS. 21A and 21B are illustrations depicting an example cancellation area;

FIGS. 22A and 22B are illustrations depicting another cancellation example;

FIGS. 23A, 23B, and 23C are illustrations depicting an example in which approval or cancellation is selected; and

FIG. 24 is an illustration depicting an example in which cancellation is determined based on the speed when drawing is completed.

### DESCRIPTION OF EMBODIMENTS

In recent years, almost any location in space is used as a display due to improvement of the performance of projectors and displays. In such a situation, it is important to display how large window at which position on which display.

For instance, assume that a user desires to display an application screen on one of a plurality of displays installed in a room using an application on a client terminal such as a smart phone at hand. In this case, when the position of another display is selected as a default, an application screen may be displayed, for instance, on a display far from the display which is intended to be used by the user. In this case, the user has to perform an operation to move the window on the application screen from the far display to an intended position of the intended display. For the size of the window, an operation has to be performed, such as dragging the edge of the window to adjust the size.

In order to avoid such a cumbersome operation, it is desirable that the system estimate the area of a window intended by a user. In general, it is however difficult to automatically estimate an intention of a user.

When there is a high degree of freedom in choosing a display area of a window like this, it is desirable that the system estimate an appropriate area for displaying a window. Conventional techniques, however, do not provide sufficient usability.

Thus, as an aspect, the disclosed embodiment aims to improve the usability in content display coordination between a client terminal and a display.

Hereinafter, a preferred embodiment of the present disclosure will be described.

<Configuration>

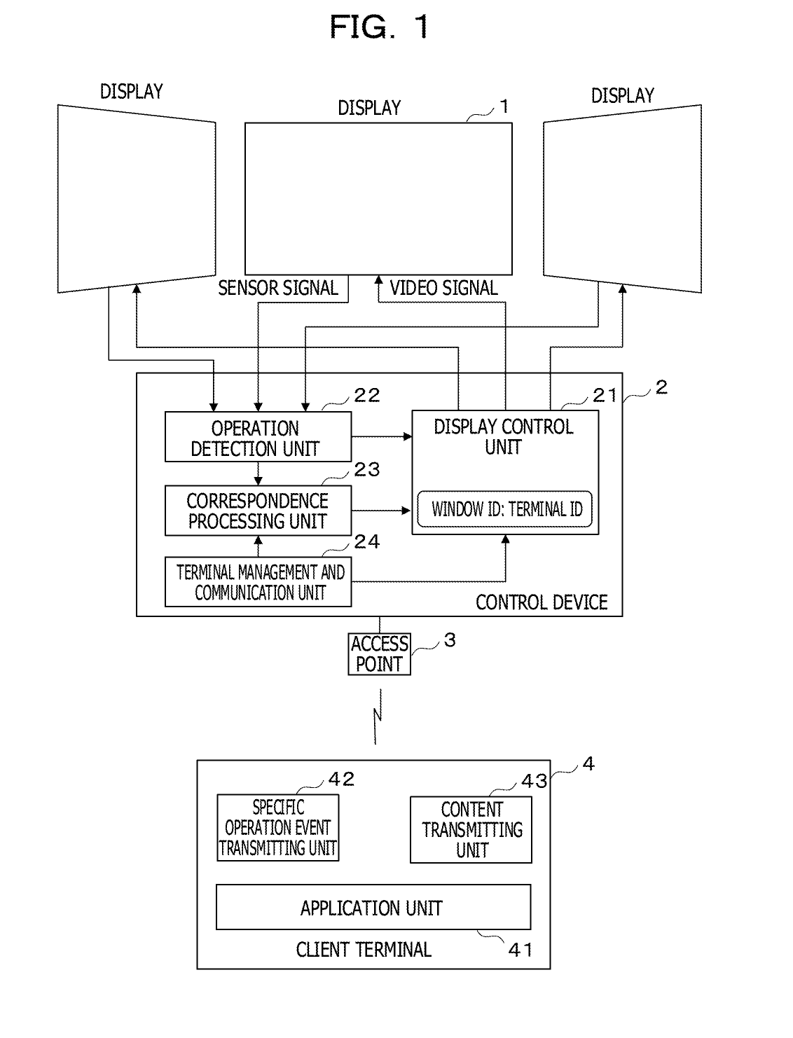

FIG. 1 is a diagram depicting an example configuration of a system according to an embodiment. In FIG. 1, a display 1 is provided on the surface of the wall of a facility such as a conference room. Although three pieces of the display 1 are provided in the depicted example, any number (greater than zero) of pieces of the display 1 may be provided. The display 1 has functions of receiving an input of a video signal, displaying a video on a screen, detecting a touch operation with a user's finger or a pen, and outputting a sensor signal including the coordinates of touched location.

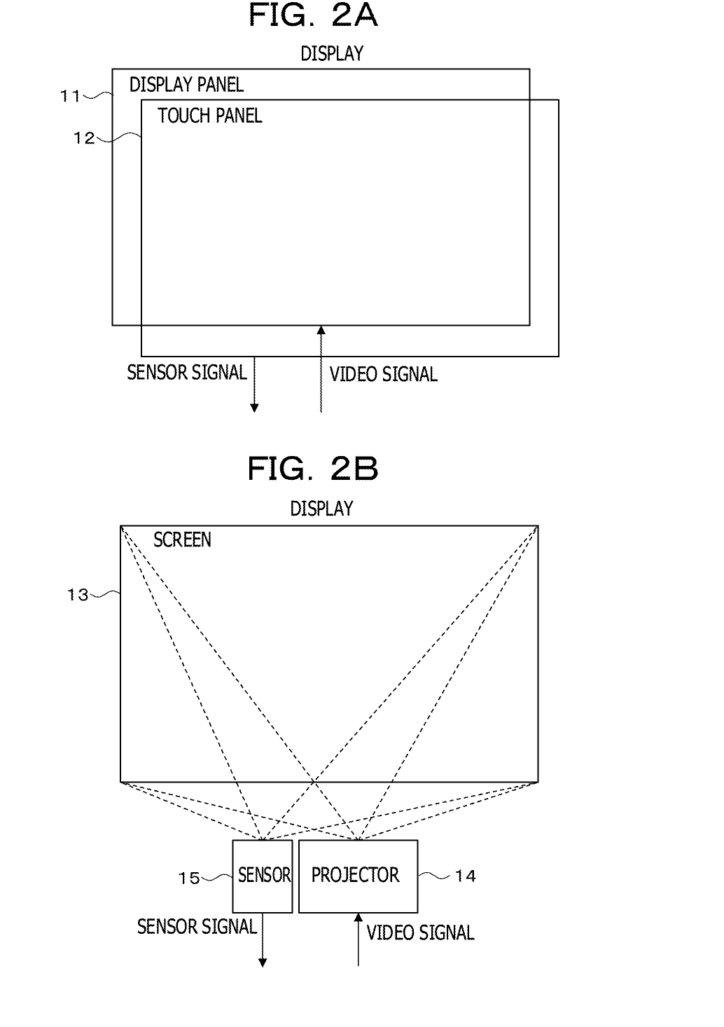

FIGS. 2A and 2B are each an illustration depicting an example configuration of the display 1. FIG. 2A depicts a type of display which is provided with a touch panel 12 on the front surface of a display panel 11. The display panel 11 receives an input of a video signal and displays a video on a screen, and the touch panel 12 detects a touch operation by a user and outputs a sensor signal. FIG. 2B depicts a type of display which is provided with a projector 14 and a sensor 15. The projector 14 receives an input of a video signal and projects the video on a screen 13. The sensor 15 detects a touch operation to the screen 13 with a user's finger and outputs a sensor signal.

Returning to FIG. 1, the display 1 is connected to a control device 2 that controls screen display of the display 1. In addition, the control device 2 is connected to an access point 3.

The control device 2 includes a display control unit 21, an operation detection unit 22, a correspondence processing unit 23, and a terminal management and communication unit 24. The display control unit 21 has functions of outputting a video signal to the display 1 and controlling screen display. In particular, the display control unit 21 controls the display of content, distributed from a client terminal 4, on a window frame designated by a user on the display 1, according to the correspondence between a window ID and a terminal ID.

The operation detection unit 22 has functions of detecting a user's touch operation based on a sensor signal from the display 1 and detecting a user's operation (designation). In particular, the operation detection unit 22 detects a designation from a user as to the position, size and other attributes of a window frame on the display 1. The correspondence processing unit 23 has a function of bringing a user-designated window frame detected by the operation detection unit 22 into correspondence with a client terminal 4 which is confirmed to be present in a vicinity by the terminal management and communication unit 24. The terminal management and communication unit 24 has functions of detecting the presence of the client terminal 4 via the access point 3, performing processing of check-in (login) as occasion calls, and communicating with the client terminal 4.

The client terminal 4 includes an application unit 41, a specific operation event transmitting unit 42, and a content transmitting unit 43. The application unit 41 has a function of executing any application (an application program, an application). The specific operation event transmitting unit 42 has a function of transmitting the fact of execution of a specific operation to the control device 2 as an event when a specific operation (for instance, a shake operation of the client terminal 4 where the shake refers to shaking of the client terminal 4 by hand) is used for bringing a user-designated window frame into correspondence with a client terminal 4. The content transmitting unit 43 has a function of transmitting content to be displayed on a window of the display 1 to the control device 2.

It is to be noted that instead of transmitting the content from the client terminal 4 to the control device 2, the content may be directly obtained by transferring an application in the client terminal 4 to the control device 2 and executing the application by the control device 2 in synchronization with the client terminal 4. In this case, transmission of the content via the access point 3 is unnecessary, and thus it is possible to display the content without delay.

It is to be noted that the control device 2 and the client terminal 4 have a hardware configuration of a general computer device. In other words, the control device 2 and the client terminal 4 each have a central processing unit (CPU), a read only memory (ROM), a random access memory (RAM), a non-volatile random access memory (NVRAM), an auxiliary storage device, and a wireless interface.

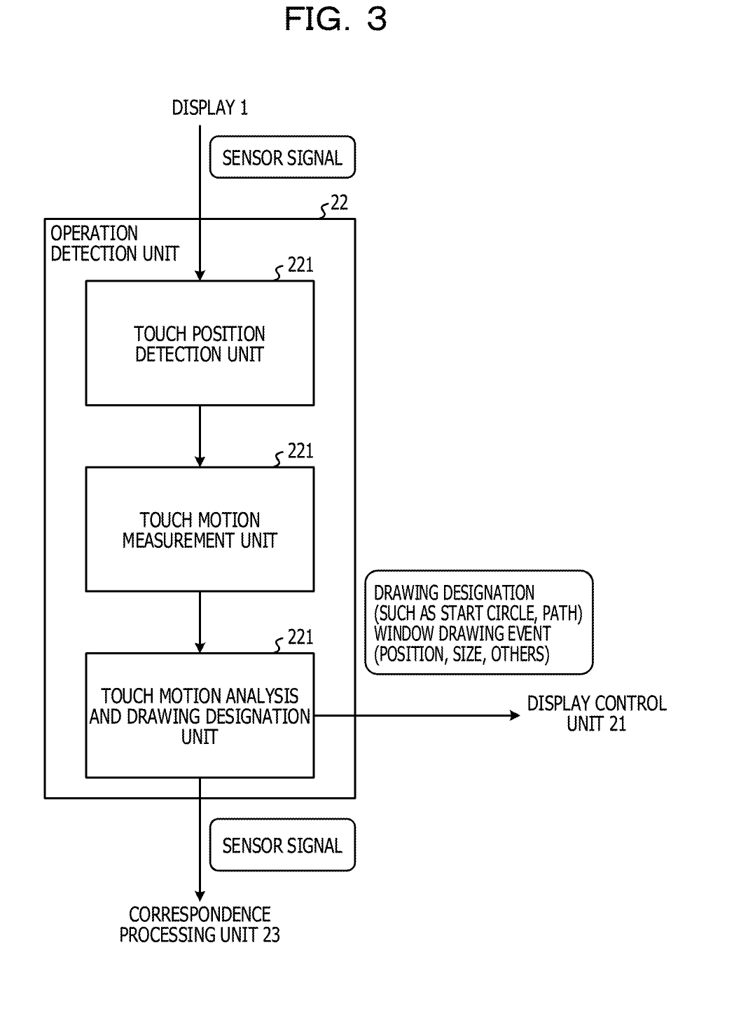

FIG. 3 is a diagram depicting an example configuration of the operation detection unit 22 of the control device 2. In FIG. 3, the operation detection unit 22 includes a touch position detection unit 221, a touch motion measurement unit 222, and a touch motion analysis and drawing designation unit 223.

The touch position detection unit 221 has a function of detecting a touch position (coordinates) based on a sensor signal from the display 1. The touch motion measurement unit 222 has a function of measuring touch motion (such as a path) based on the touch position detected by the touch position detection unit 221. The touch motion analysis and drawing designation unit 223 has functions of analyzing the touch motion measured by the touch motion measurement unit 222, giving a drawing designation to the display control unit 21, and giving a window drawing event to the display control unit 21 in the case of an operation of designating a window frame. The touch motion analysis and drawing designation unit 223 also notifies the correspondence processing unit 23 of an occurrence of a window drawing event.

<Overall Processing>

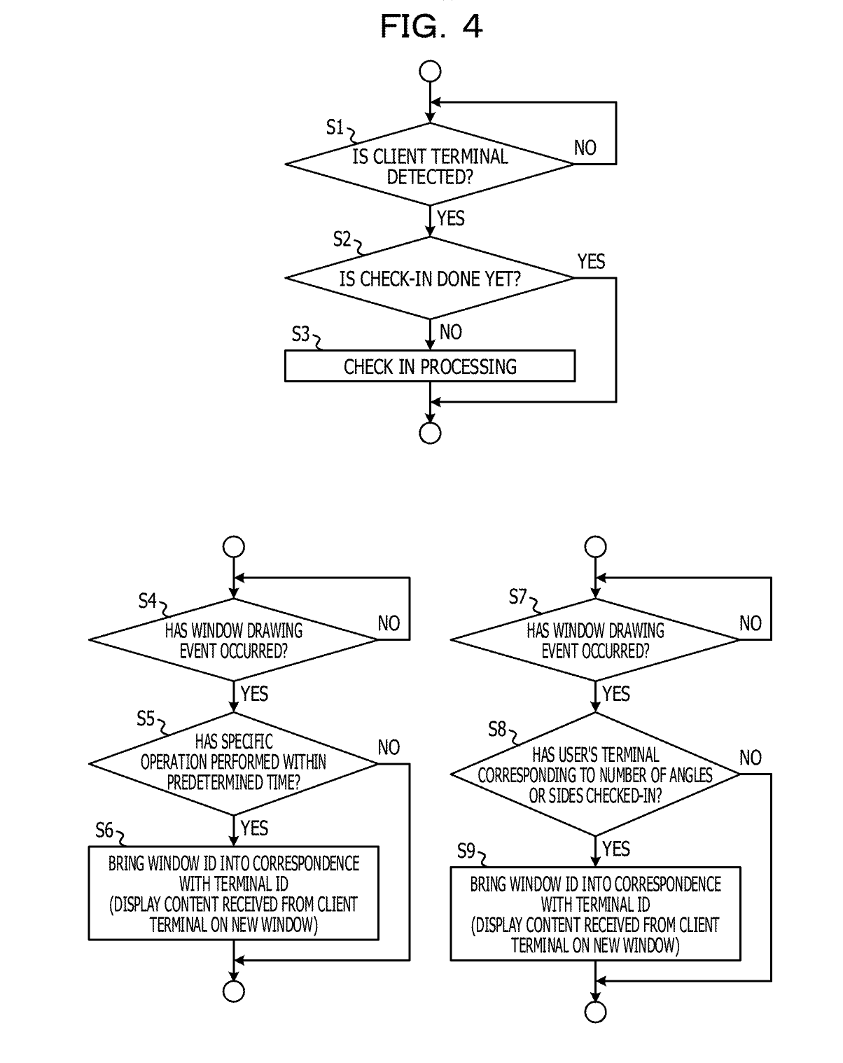

FIG. 4 is a flow chart depicting an overall processing example in the above-described embodiment. In FIG. 4, upon detecting the client terminal 4 via the access point 3 (yes in step S1), when check-in is not done yet (no in step S2), the terminal management and communication unit 24 of the control device 2 performs check-in processing (step S3) in which presenting a user ID, a password, and the like are requested.

Subsequently, the correspondence processing unit 23 of the control device 2, when receiving a notification of an occurrence of a window drawing event from the operation detection unit 22 (yes in step S4), checks whether or not a predetermined operation (for instance, shake) has been performed within a predetermined preset time by the specific operation event transmitting unit 42 of the client terminal 4 via the terminal management and communication unit 24 (step S5).

When a predetermined operation has been performed (yes in step S5), the correspondence processing unit 23 brings the window ID for the window drawing event into correspondence with the terminal ID of the client terminal 4 in which a predetermined operation has been performed, and sets the correspondence in the display control unit 21 (step S6). Consequently, the display control unit 21 displays the content received from the content transmitting unit 43 of the client terminal 4, on the window with a corresponding window ID.

Also, the number of angles and sides of a handwritten figure in an operation of designating a window frame is registered in advance in relation to a user, thereby making it possible to establish the correspondence without performing a specific operation such as shake.

In this case, the correspondence processing unit 23 of the control device 2, when receiving a notification of an occurrence of a window drawing event from the operation detection unit 22 (yes in step S7), checks based on the number of angles or sides obtained from a path whether or not the client terminal 4 of a user corresponding to the number of angles and sides of a handwritten figure has already checked-in (step S8).

When the client terminal 4 has already checked-in (yes in step S8), the correspondence processing unit 23 brings the window ID for the window drawing event into correspondence with the terminal ID of the user-check-in client terminal 4 corresponding to the number of angles or sides, and sets the correspondence in the display control unit 21 (step S9). Consequently, the display control unit 21 displays the content received from the content transmitting unit 43 of the client terminal 4, on the window with a corresponding window ID.

Also, the path of a handwritten signature of a user may be pre-registered, and a user may also be authenticated using the signature drawn by the user in an operation of designating a window frame. In this case, the terminal ID of the client terminal 4 of a user is pre-registered or a user is prompted to perform a predetermined operation such as shake, thereby making it possible to simultaneously perform sign-in and establishment of a correspondence between a window ID and a terminal ID.

<Processing of Operation Detection Unit>

[First Processing Example]

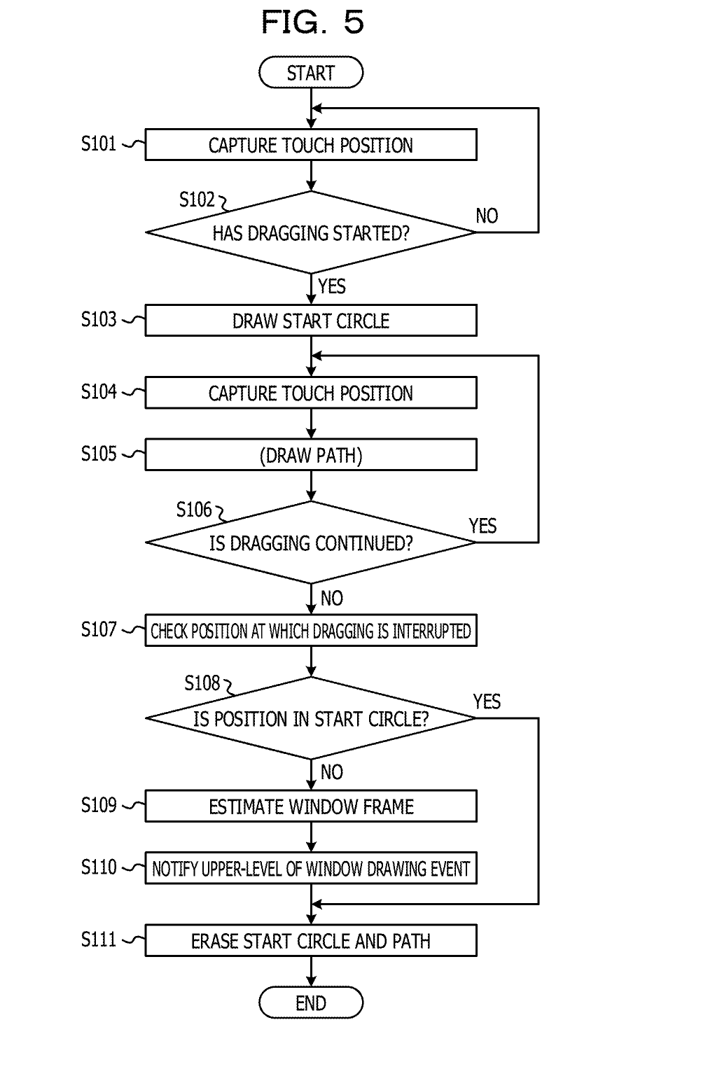

FIG. 5 is a flow chart of a first processing example of the operation detection unit 22 of the control device 2. In FIG. 5, the operation detection unit 22, when starting processing, captures a touch position from a sensor signal of the display 1 (step S101), and determines based on a change in coordinates whether or not a user has started dragging (operation of sliding the touch position) (step S102).

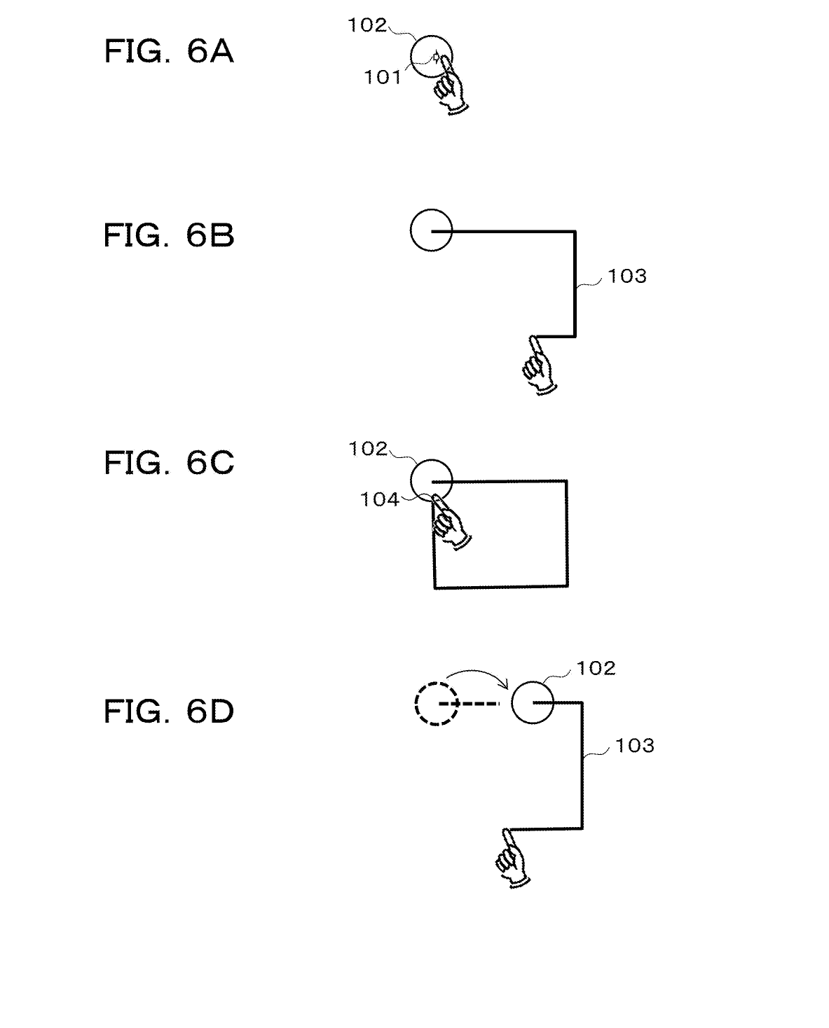

When it is determined that dragging is started (yes in step S102), the operation detection unit 22 draws a start circle centered on the position at which dragging is started (step S103). The start circle is for informing a user of the goal of dragging, and is not limited to a circle and may be any closed figure. Also, display of such a figure allows to distinguish a window display designation operation from other pointing operations. FIG. 6A depicts an example in which a start circle 102 is drawn centered on a drag start position 101.

Subsequently, returning to FIG. 5, the operation detection unit 22 captures a touch position from a sensor signal of the display 1 (step S104), and draws a path (step S105). It is to be noted that drawing of a path may not be performed. FIG. 6B depicts an example in which drawing of a path is performed.

Subsequently, returning to FIG. 5, the operation detection unit 22 determines whether or not dragging is continued (step S106), and when it is determined that dragging is continued (yes in step S106), the flow returns to “capture touch position” (step S104).

When it is determined that dragging is not continued (no in step S106), the operation detection unit 22 checks a position at which dragging is interrupted (step S107), and determines whether or not the position is in the start circle (step S108).

When it is determined that the position is in the start circle (yes in step S108), the operation detection unit 22 estimates a window frame (step S109). FIG. 6C depicts an example in which a position 104 at which dragging is interrupted is in the start circle 102.

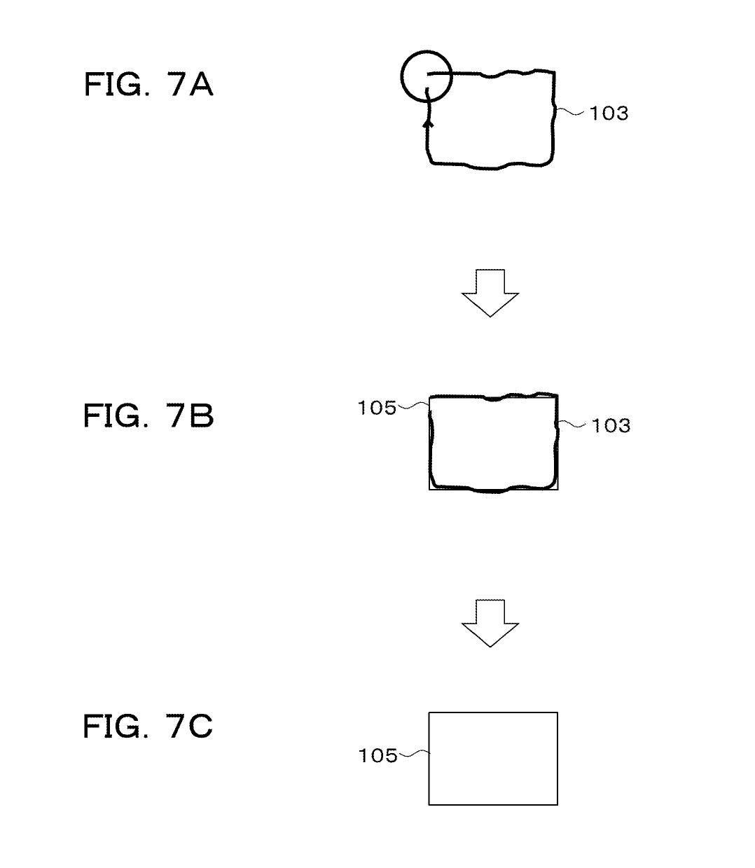

FIGS. 7A to 7C are illustrations depicting a processing example of estimation of a window frame. The window frame is limited to a rectangle having horizontal upper and lower sides and a rectangle closest to the path created by a user's dragging is estimated to be a window frame. Assume that estimation is started based on a path 103 as depicted in FIG. 7A. As depicted in FIG. 7B, a rectangle 105 is determined such that the square sum of differences from the path 103 (differences in perpendicular direction to each side) has a minimum, and a figure as depicted in FIG. 7C is estimated. Although estimation by the least square method has been described, optionally, a rectangle may be determined such that the sum of differences from the path has a minimum. In addition, a rectangle inscribed in the path and a rectangle circumscribed about the path are determined, and an intermediate rectangle may also be estimated. Additionally, a geometric figure (such as a polygon, a circle) which is closest to the path created by a user's dragging may be estimated then a rectangle may be estimated based on the geometric figure. In the case where a figure other than a rectangle is permitted as a window frame, a geometric figure as it is may be estimated as a window frame. In the case where a user is identified based on the number of angles and sides of a figure dragged, the number of angles and sides are obtained when a permitted figure is estimated based on the path created by a user's dragging.

Returning to FIG. 5, the operation detection unit 22, after estimating a window frame, notifies the upper-level display control unit 21 of a window drawing event (step S110), erases the start circle and the path (if the path has been drawn) (step S111), and completes the processing.

When it is determined that the position at which dragging is interrupted is not in the start circle (no in step S108), estimation is not performed, and the start circle and the path (if the path has been drawn) are erased (step S111) and the processing is completed. Thus, when designation of a window frame is desired to be changed before the dragging reaches the start circle, cancellation of the designation is substantially made by interrupting the dragging, and continuous dragging allows the processing to be performed again from step S101. FIG. 6D depicts an example in which the start circle and the path depicted by a dashed line are erased, and new start circle 102 and path 103 are drawn.

[Second Processing Example]

This processing example allows input of a signature for identifying and authenticating a user when an operation of designating a window frame is performed by the user. Except for this, the second processing example is the same as the first processing example.

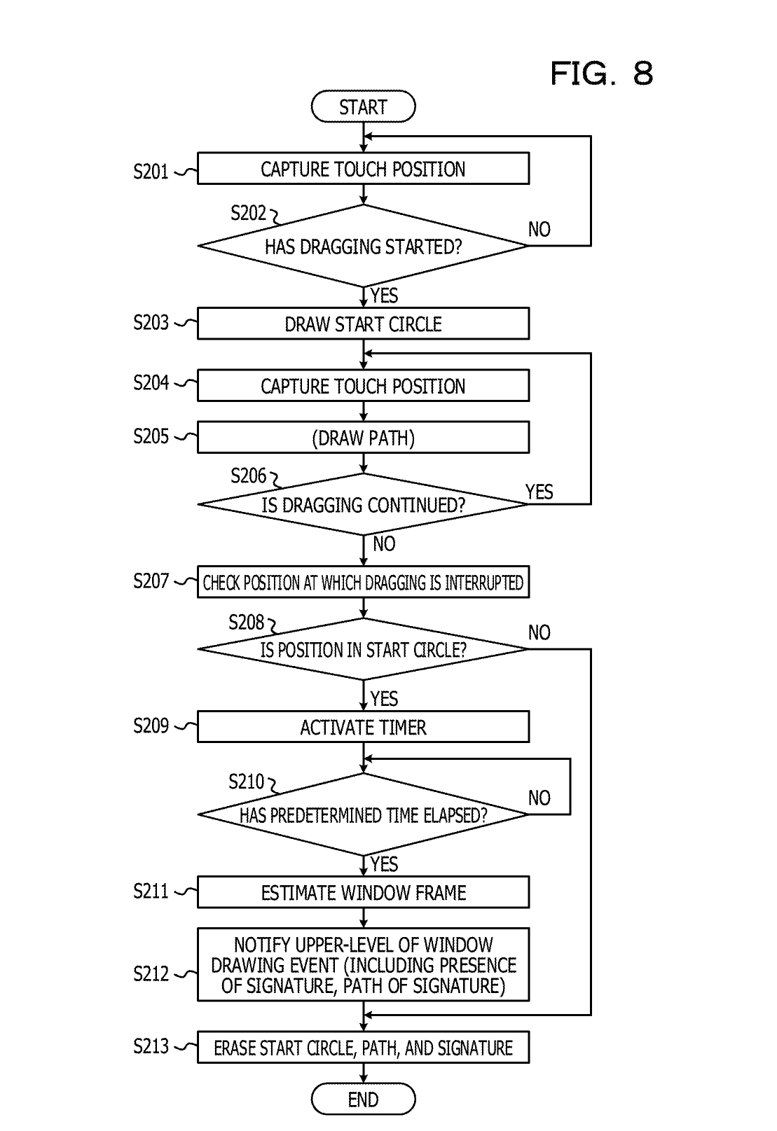

FIG. 8 is a flow chart of the second processing example of the operation detection unit 22 of the control device 2. In FIG. 8, the operation detection unit 22, when starting processing, captures a touch position from a sensor signal of the display 1 (step S201), and determines based on a change in coordinates whether or not a user has started dragging (operation of sliding the touch position) (step S202).

When it is determined that dragging is started (yes in step S202), the operation detection unit 22 draws a start circle centered on the position at which dragging is started (step S203).

Subsequently, the operation detection unit 22 captures a touch position from a sensor signal of the display 1 (step S204), and draws a path (step S205). It is to be noted that drawing of a path may not be performed.

Subsequently, the operation detection unit 22 determines whether or not dragging is continued (step S206), and when it is determined that dragging is continued (yes in step S206), the flow returns to “capture touch position” (step S204).

When it is determined that dragging is not continued (no in step S206), the operation detection unit 22 checks a position at which dragging is interrupted (step S207), and determines whether or not the position is in the start circle (step S208).

When it is determined that the position is in the start circle (yes in step S208), the operation detection unit 22 activates a timer (step S209), and stays on stand-by until a predetermined time elapses (step S210). It is to be noted that the predetermined time is provided for a user to write a signature in a window frame, and capturing a touch position and drawing a path are continued for obtaining the path of the signature.

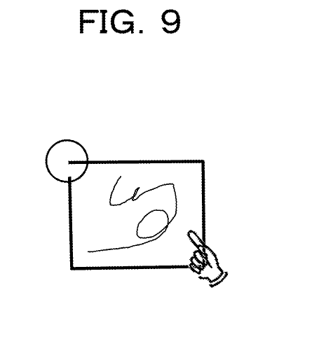

When a predetermined time elapses (yes in step S210), the operation detection unit 22 estimates a window frame (step S211) and notifies the display control unit 21 of a window drawing event (step S212). In this step, presence of a signature and the path of a signature (if a signature is provided) are included in the notification. The path of the signature notified to the display control unit 21 is compared with the path of the signature registered in relation to the user in advance, and is used for authentication. FIG. 9 is an illustration depicting an example of handwritten signature and in the example, after the path enters the start circle and is interrupted, a signature is drawn in the frame.

Subsequently, returning to FIG. 8, the operation detection unit 22 erases the start circle, the path (if the path has been drawn), and the signature (if the signature has been written) (step S213), and completes the processing. When it is determined that the position at which dragging is interrupted is not in the start circle (no in step S208), estimation is not performed, and the drawn figure is erased (step S213), and the processing is completed.

[Third Processing Example]

In this processing example, a frame probability (the possibility of being recognized as a predetermined figure) is evaluated by which a window frame may be estimated based on the path created by a user's dragging, and the size of the start circle is adjusted according to the evaluation. In other words, when the path is further drawn, which allows a window frame to be estimated, the operation may be completed without continuing to drag to the start circle in the original size so that time may be saved. Except for this, the third processing example is the same as the first processing example.

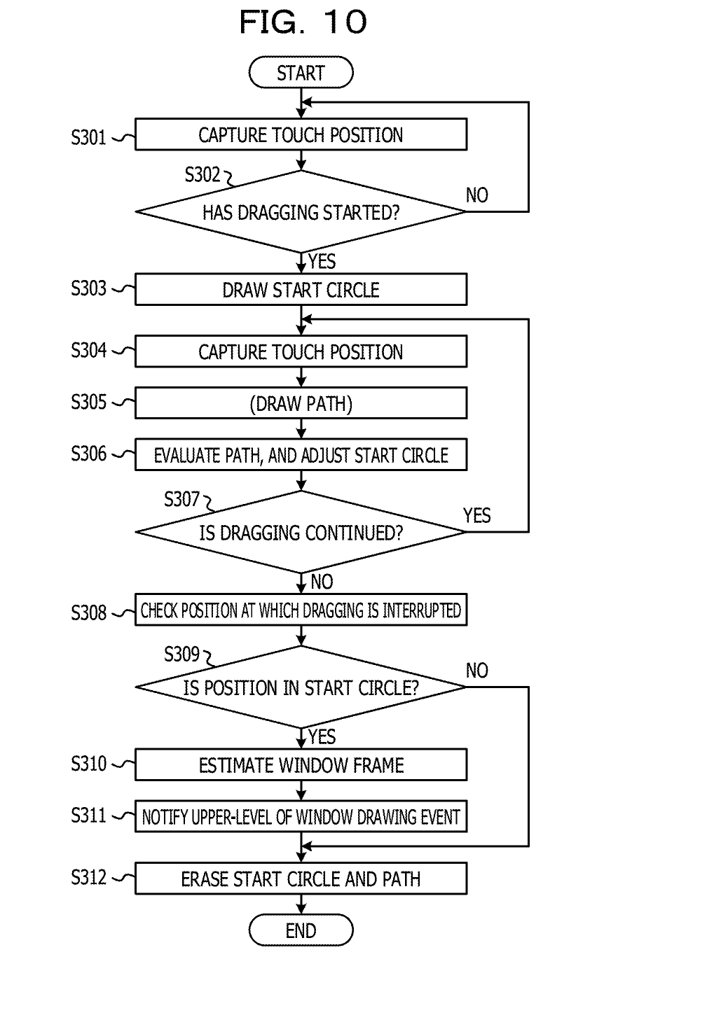

FIG. 10 is a flow chart of the third processing example of the operation detection unit 22 of the control device 2. In FIG. 10, the operation detection unit 22, when starting processing, captures a touch position from a sensor signal of the display 1 (step S301), and determines based on a change in coordinates whether or not a user has started dragging (operation of sliding the touch position) (step S302).

When it is determined that dragging is started (yes in step S302), the operation detection unit 22 draws a start circle centered on the position at which dragging is started (step S303).

Subsequently, the operation detection unit 22 captures a touch position from a sensor signal of the display 1 (step S304), and draws a path (step S305). It is to be noted that drawing of a path may not be performed.

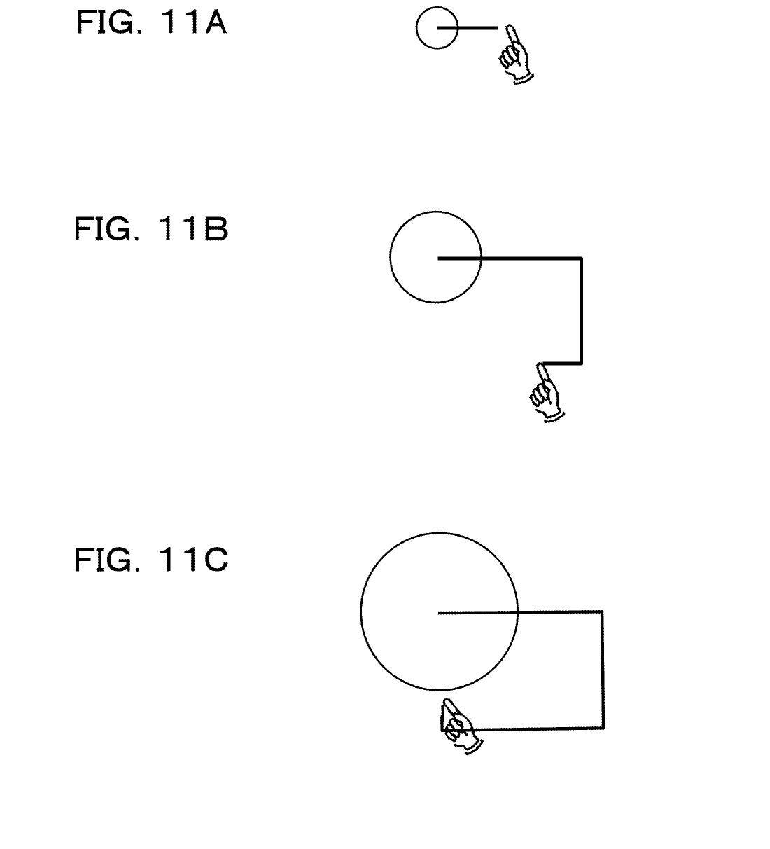

Subsequently, the operation detection unit 22 evaluates the path and adjusts the size of the start circle (step S306). FIGS. 11A to 11C are each an illustration depicting an example change of display of the start circle. FIG. 11A depicts the start circle immediately after dragging is started, and for instance, in the case of estimating a rectangle, with three sides drawn, the frame probability is evaluated to be high, and the start circle is enlarged as depicted in FIG. 11B. When the path is further drawn, the start circle is further enlarged as depicted in FIG. 11C. The details of the evaluation of the path and adjustment of the size of the start circle will be described later.

Subsequently, returning to FIG. 10, the operation detection unit 22 determines whether or not dragging is continued (step S307), and when it is determined that dragging is continued (yes in step S307), the flow returns to “capture touch position” (step S304).

When it is determined that dragging is not continued (no in step S307), the operation detection unit 22 checks a position at which dragging is interrupted (step S308), and determines whether or not the position is in the start circle (step S309).

When it is determined that the position is in the start circle (yes in step S309), the operation detection unit 22 estimates a window frame (step S310).

Subsequently, the operation detection unit 22 notifies the display control unit 21 of a window drawing event (step S311), erases the start circle and the path (if the path has been drawn) (step S312), and completes the processing.

When it is determined that the position at which dragging is interrupted is not in the start circle (no in step S309), estimation is not performed, and the start circle and the path are erased (if the path has been drawn) (step S312).

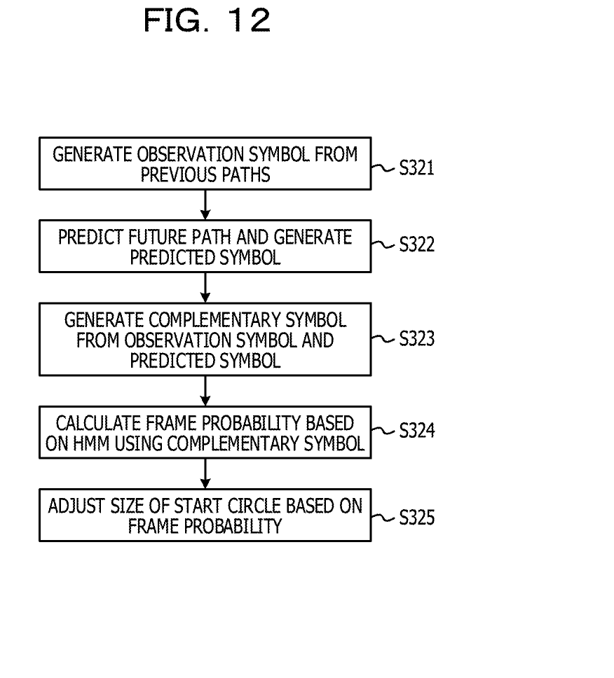

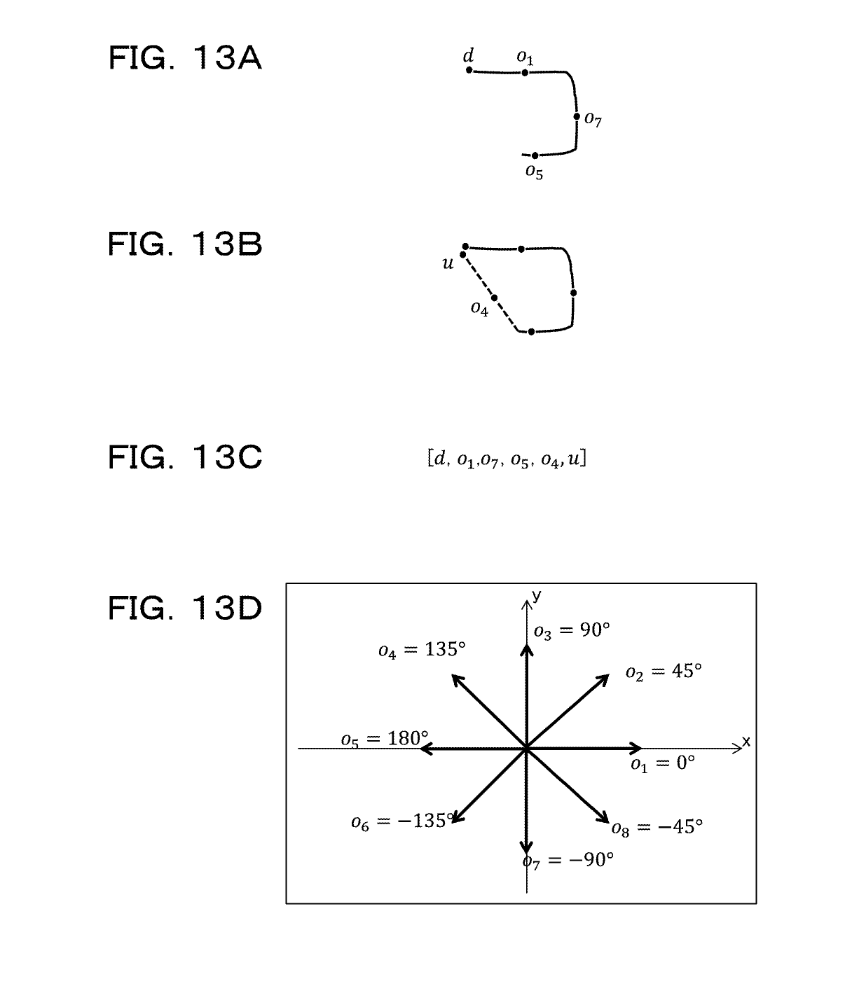

FIG. 12 is a flow chart depicting a processing example of evaluation of the path and adjustment of the start circle. In FIG. 12, the operation detection unit 22 generates an observation symbol from the previous paths (step S321). FIG. 13A depicts example observation symbols, and [d, o₁, o₇, o₅] is an observation symbol sequence. Here, d indicates the starting point (pen down) of dragging. Here, o₁, o₇, o₅ are the symbols that are defined according to a moving direction of the path as depicted in FIG. 13D. That is, o₁ corresponds to rightward, o₇ corresponds to downward, and o₅ corresponds to leftward.

Subsequently, returning to FIG. 12, the operation detection unit 22 predicts a future path, and generates a predicted symbol (step S322). More specifically, for instance, a straight line is connected from slightly back of the most recently observed symbol to the start point, and a predicted symbol is generated on the straight line. FIG. 13B depicts example predicted symbols, and [o₄, u] forms a predicted symbol sequence. The end point (pen up) of dragging is indicated by u. Here, o₄ follows the definition of FIG. 13D and corresponds to left diagonally upward.

Subsequently, returning to FIG. 12, the operation detection unit 22 generates a complementary symbol from the observation symbols and the predicted symbols (step S323). FIG. 13C depicts an example complementary symbol sequence, and [d, o₁, o₇, o₅, o₄, u] forms a complementary symbol sequence based on the example of FIGS. 13A and 13B.

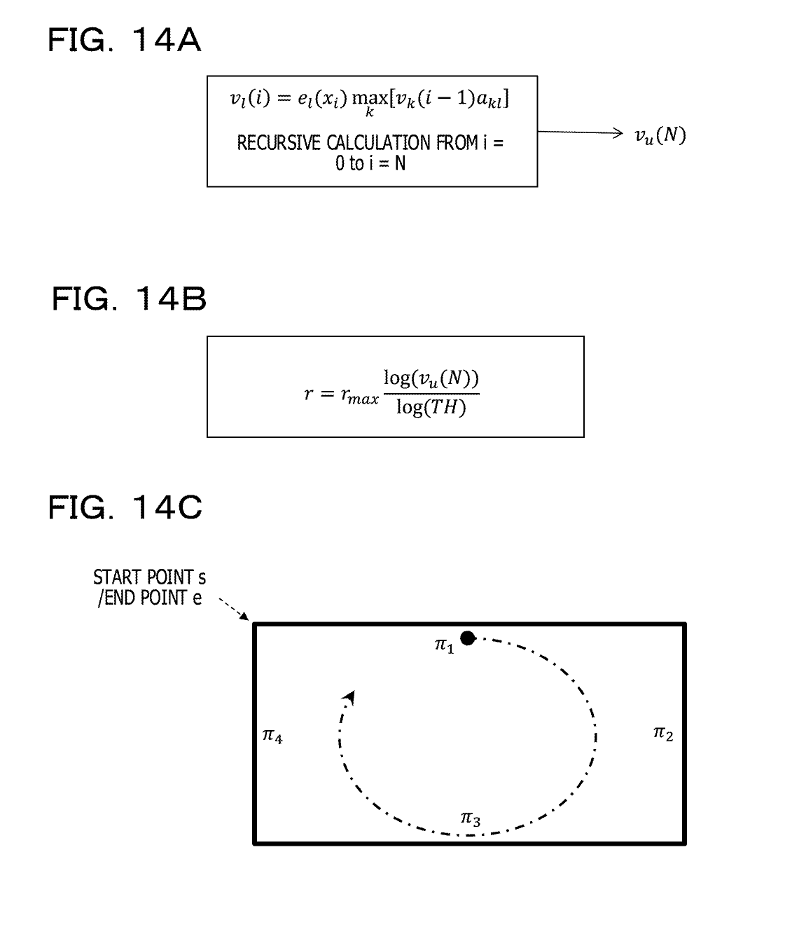

Subsequently, returning to FIG. 12, the operation detection unit 22 calculates a frame probability based on a hidden markov model (HMM) using the complementary symbols (step S324). FIGS. 14A to 14C depict an example calculation of a frame probability and the size of the start circle. In FIG. 14A, vₗ(i) indicates a probability that a state is l when the i-th symbol is observed. When a figure to be estimated is a rectangle and dragging is done in the clockwise direction from the upper left (s is a start point of the path and e is an end point of the path), as depicted in FIG. 14C, π₁ indicates a state being on the upper side, π₂ indicates a state being on the right side, π₃ indicates a state being on the lower side, and π₄ indicates a state being on the left side. Also, in FIG. 14A, eₗ(xᵢ) is the probability that symbol xᵢ is observed when in a state l, and is given in advance as a preset observation probability table. Here, aₖₗ is a transition probability from state k to state l, and is given as a preset state transition probability table. Here, max[ ] indicates the value of a maximum element extracted from the elements in the parentheses. The frame probability is vᵤ (N) that is determined by performing recursive calculation for vₗ(i) from i=0 to i=N.

Subsequently, returning to FIG. 12, the operation detection unit 22 adjusts the size of the start circle based on the frame probability (step S325). FIG. 14B depicts an example calculation expression for the radius r of the start circle, and the radius r is determined by multiplying a maximum radius rₘₐₓ by the ratio of the logarithm of vᵤ (N) calculated in FIG. 14A to the logarithm of value TH which is defined in a practical operation.

[Modification of Third Processing Example]

In the third processing example described above, the size of the start circle (closed start figure) is adjusted based on the evaluation of “frame probability”. In addition, the following modification is possible.

As an example, currently drawn path is continuously evaluated and when the forward direction of the path is toward the closed start figure, the size of the closed start figure is adjusted according to the distance between the position of the current path and the closed start figure. This makes it possible to reduce the time for drawing the frame.

As another example, for the currently drawn figure, the number of angles is counted, and the size of the closed start figure is adjusted according to the number of angles. In other words, since the possibility of successful estimation increases as the number of angles of the path increases, the closed start figure is enlarged so that drawing of the path may be completed earlier.

[Fourth Processing Example]

In this processing example, when a user starts to drag (starts drawing), a closed figure such as a start circle is not displayed, and it is checked whether the figure of a window frame may be estimated in the process of dragging. When the estimation is possible, a candidate figure is displayed and is determined after confirmation by a user.

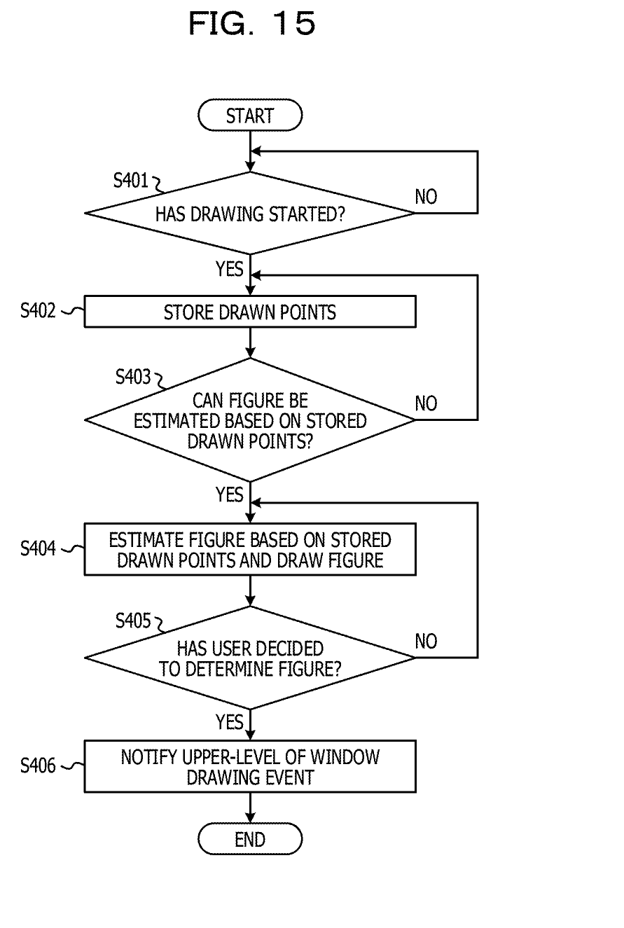

FIG. 15 is a flow chart of the fourth processing example of the operation detection unit 22 of the control device 2. In FIG. 15, the operation detection unit 22, when starting processing, determines whether or not a user has started drawing based on a change in the coordinates of a captured touch position (step S401).

When it is determined that a user has started drawing (yes in step S401), the operation detection unit 22 stores drawn points (step S402) and determines whether or not a figure may be estimated based on the stored drawn points (step S403). For determination as to whether or not a figure may be estimated, the same technique as the evaluation of a frame probability depicted in FIGS. 12 to 14C may be used, for instance. It is to be noted that even when a figure may be estimated, if the area of the figure is smaller than a predetermined value, it may be determined that estimation is not possible because the smaller area is probably due to a mistake in drawing.

When it is determined that a figure may not be estimated (no in step S403), the operation detection unit 22 returns to the storing of drawn points (step S402).

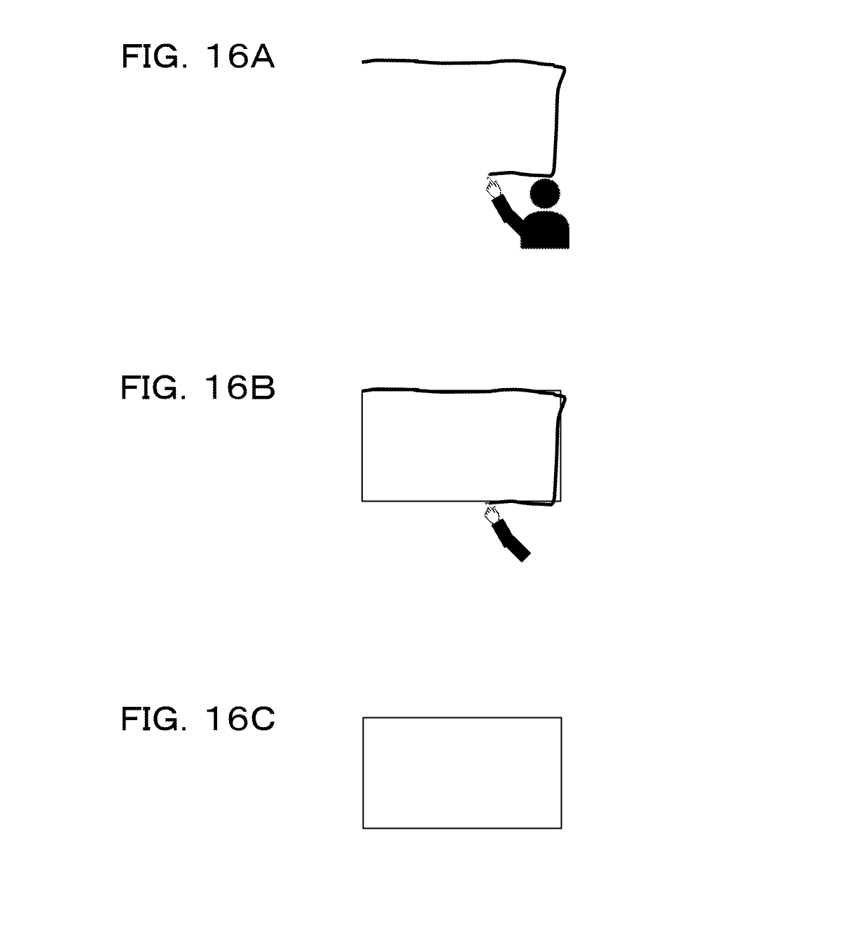

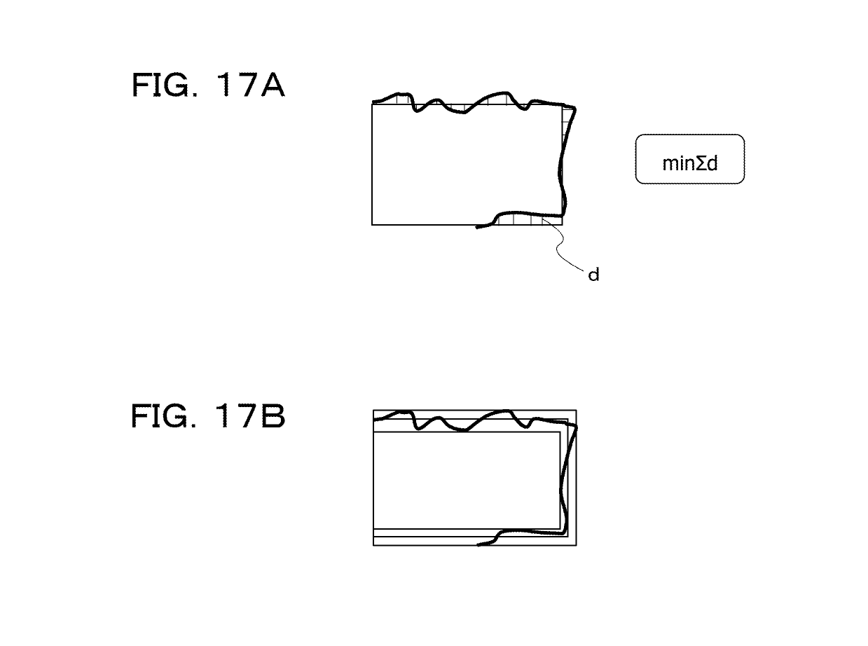

When it is determined that a figure may be estimated (yes in step S403), the operation detection unit 22 estimates a figure based on the stored drawn points and draws the figure (step S404). FIG. 16A depicts a state in which a user is drawing, and FIG. 16B depicts a state in which a figure is estimated and a candidate figure is drawn. Also, FIGS. 17A and 17B depict an example of estimation of a figure. FIG. 17A depicts an example in which a candidate figure is estimated so that the sum of the differences d between the candidate figure and the path has a minimum. FIG. 17B depicts an example in which a rectangle inscribed in the path and a rectangle circumscribed about the path are determined, and an intermediate rectangle is estimated.

Subsequently, returning to FIG. 15, the operation detection unit 22 determines whether or not a user has decided to accept the drawn candidate figure (step S405). For instance, the decision of a user includes releasing of the touch (a finger is released from the display).

When it is determined that a user has decided to accept the drawn candidate figure (yes in step S405), the operation detection unit 22 notifies the display control unit 21 of a window drawing event, erases the drawn figure (step S406), and completes the processing. It is to be noted that the candidate figure may be left on display until a window is drawn. FIG. 16C depicts a state in which the candidate figure is displayed.

[Fifth Processing Example]

In this processing example, when a user has not completed the drawing, estimation of a figure continues. Except for this, the fifth processing example is the same as the fourth processing example.

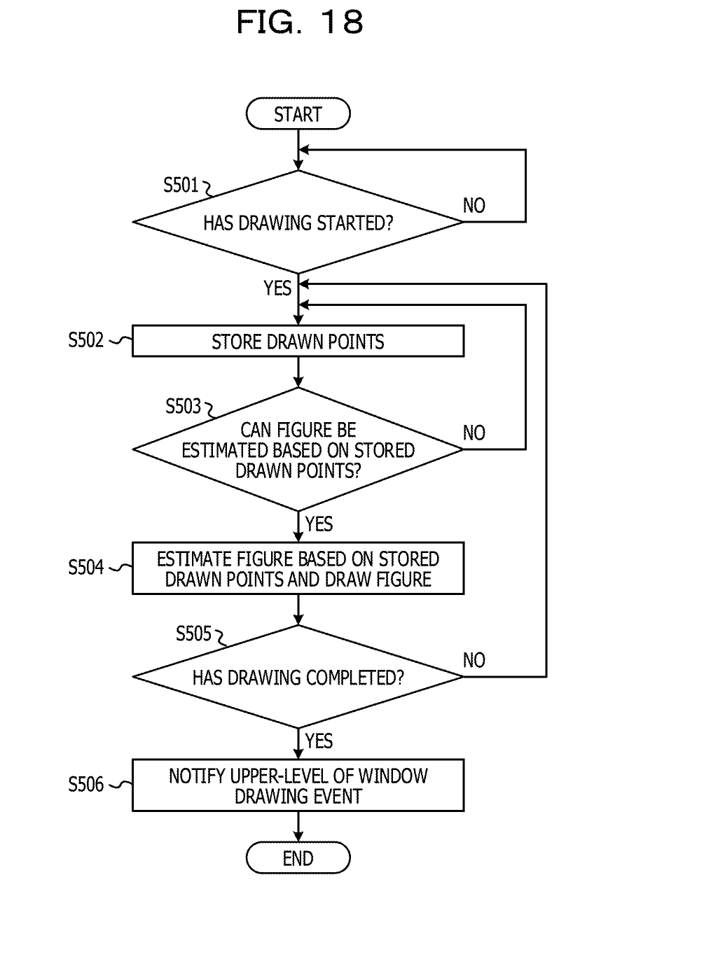

FIG. 18 is a flow chart of the fifth processing example of the operation detection unit 22 of the control device 2. In FIG. 18, the operation detection unit 22, when starting processing, determines whether or not a user has started drawing based on a change in the coordinates of a captured touch position (step S501).

When it is determined that a user has started drawing (yes in step S501), the operation detection unit 22 stores drawn points (step S502) and determines whether or not a figure may be estimated based on the stored drawn points (step S503).

When it is determined that a figure may not be estimated (no in step S503), the operation detection unit 22 returns to the storing of drawn points (step S502).

When it is determined that a figure may be estimated (yes in step S503), the operation detection unit 22 estimates a figure based on the stored drawn points and draws a candidate figure (step S504).

Subsequently, the operation detection unit 22 determines whether or not a user has completed the drawing (step S505).

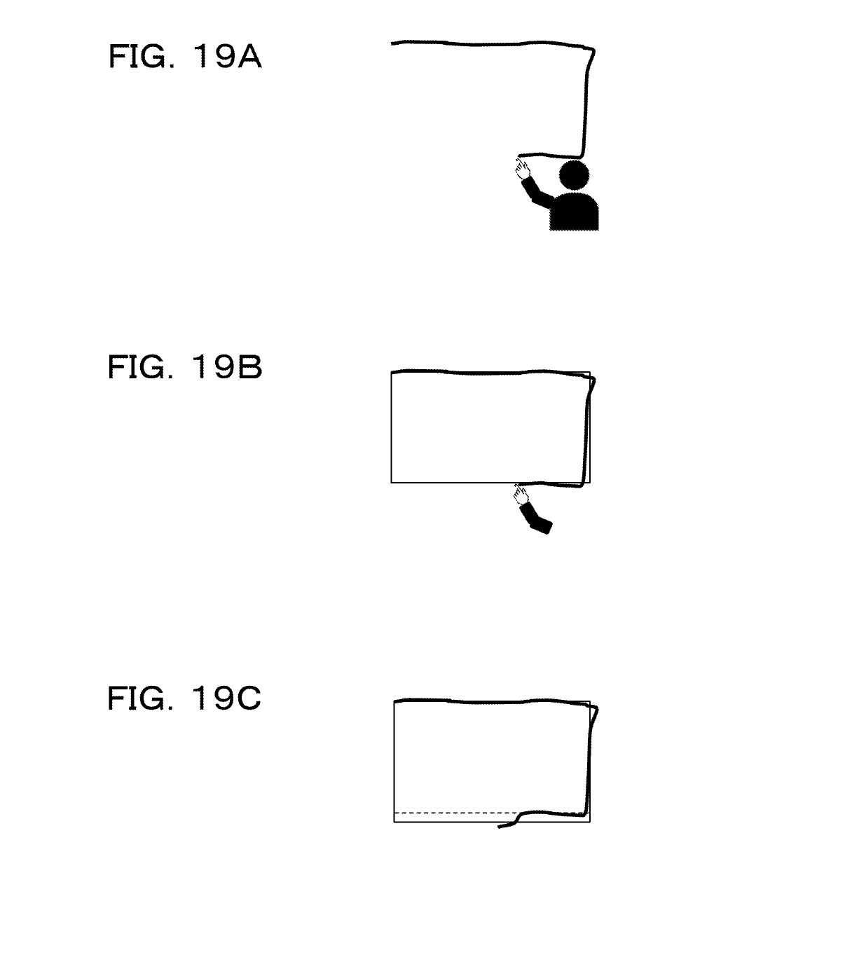

When it is determined that the drawing is not completed (no in step S505), the operation detection unit 22 returns to the storing of drawn points (step S502). FIG. 19A depicts a state in which a user is drawing, and FIG. 19B depicts a state in which a figure is estimated and a candidate figure is drawn. Also, FIG. 19C depicts a state in which when the drawing is not completed, a figure is re-estimated according to the drawing of a user, and the candidate figure is changed.

Returning to FIG. 18, when it is determined that the drawing is completed (yes in step S505), the operation detection unit 22 notifies the display control unit 21 of a window drawing event, erases the drawn figure (step S506), and completes the processing.

[Sixth Processing Example]

This processing example allows cancellation in the case where an estimated figure is not accepted by a user. Except for this, the sixth processing example is the same as the fifth processing example.

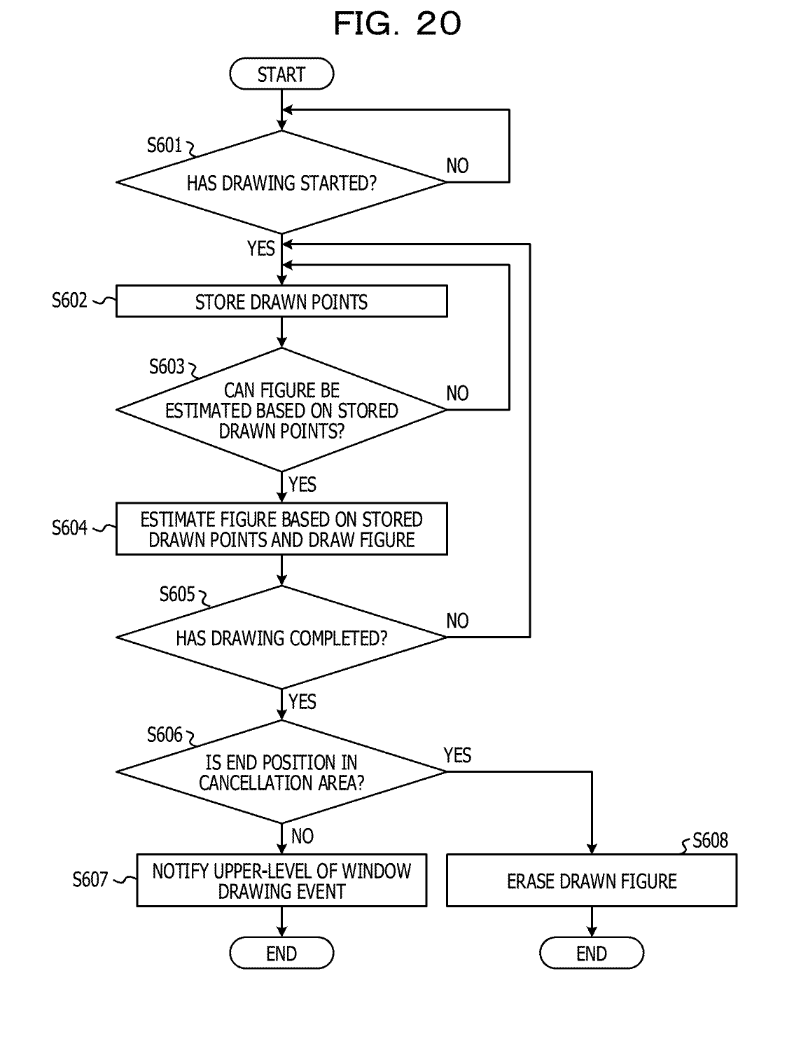

FIG. 20 is a flow chart of the sixth processing example of the operation detection unit 22 of the control device 2. In FIG. 20, the operation detection unit 22, when starting processing, determines whether or not a user has started drawing based on a change in the coordinates of a captured touch position (step S601).

When it is determined that a user has started drawing (yes in step S601), the operation detection unit 22 stores drawn points (step S602) and determines whether or not a figure may be estimated based on the stored drawn points (step S603).

When it is determined that a figure may not be estimated (no in step S603), the operation detection unit 22 returns to the storing of drawn points (step S602).

When it is determined that a figure may be estimated (yes in step S603), the operation detection unit 22 estimates a figure based on the stored drawn points and draws a candidate figure (step S604).

Subsequently, the operation detection unit 22 determines whether or not a user has completed the drawing (step S605).

When it is determined that the drawing is not completed (no in step S605), the operation detection unit 22 returns to the storing of drawn points (step S602).

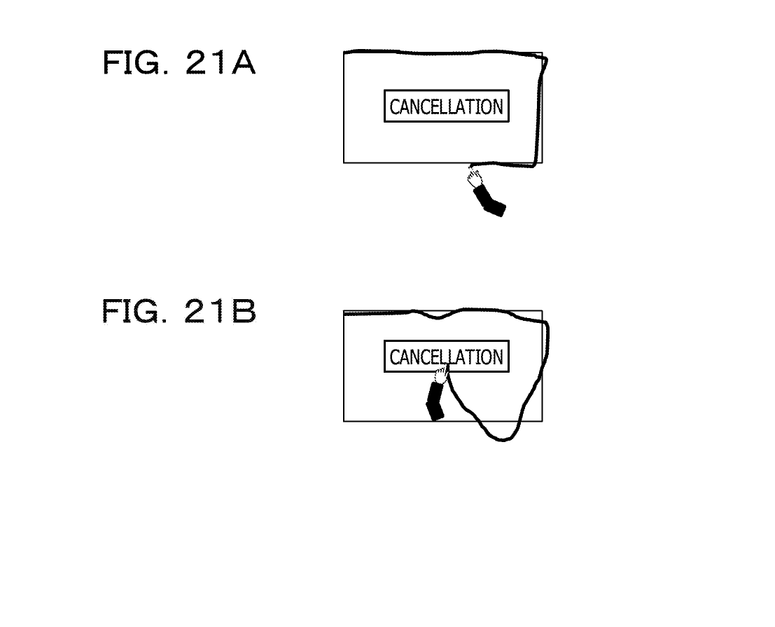

When it is determined that the drawing is completed (yes in step S605), the operation detection unit 22 determines whether or not the end position is in a cancellation area (step S606). FIG. 21A depicts a state in which the “cancellation” area is displayed in a center portion of the estimated figure, and FIG. 21B depicts a state in which drawing is completed in the “cancellation” area.

Subsequently, returning to FIG. 20, when it is determined that the end position is not in the cancellation area (no in step S606), the operation detection unit 22 notifies the display control unit 21 of a window drawing event, erases the drawn figure (step S607), and completes the processing.

When it is determined that the end position is in the cancellation area (yes in step S606), the operation detection unit 22 erases the drawn figure (step S608), and completes the processing.

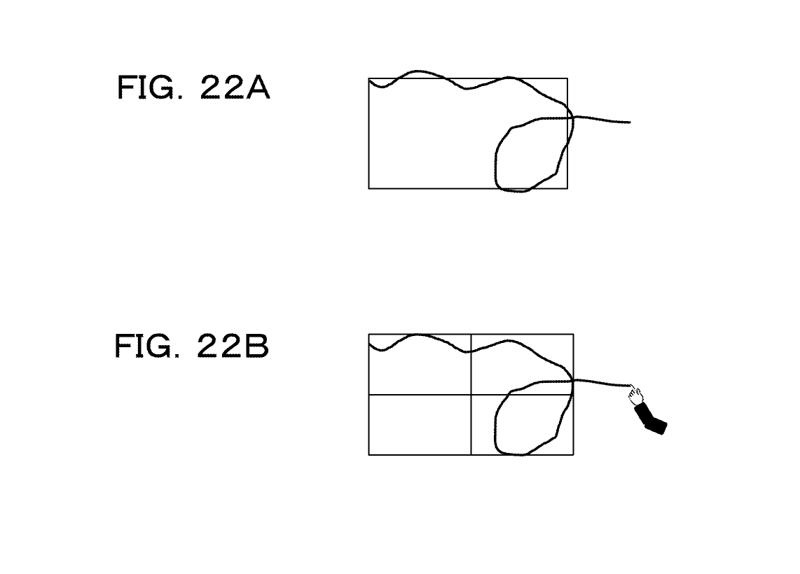

FIGS. 22A and 22B are illustrations depicting another cancellation example. When the path crosses itself as depicted in FIG. 22A, it is determined which one of quadrisected areas in an estimated figure or a circumscribed figure as depicted in FIG. 22B has the crossing. When the one of quadrisected areas is different from the divided area having the start point (when the crossing occurs at a position away from the start point), it is determined that cancellation is made. When a user intends to cancel, it is presumed that the user draws a messed-up figure or draws X due to a psychological reason. In this case, it is expected that the drawn path crosses at a position away from the start position of drawing, and a cancellation operation may be easily performed by the user without releasing the touch in an intuitive operating manner.

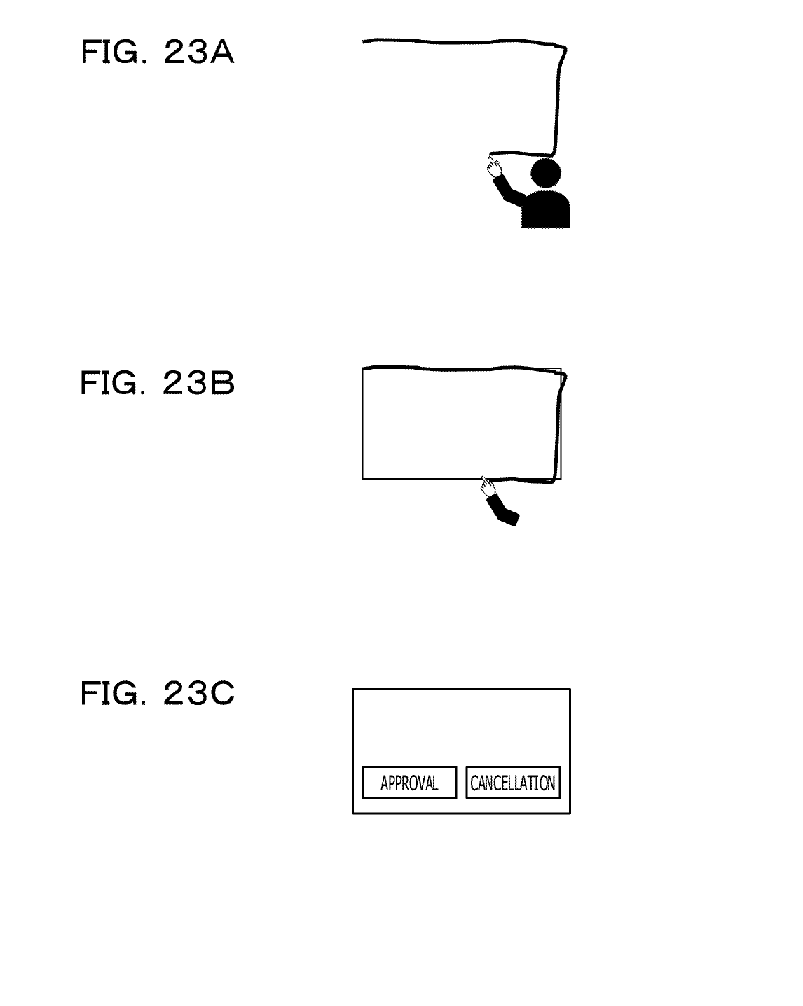

FIGS. 23A to 23C are illustrations depicting an example in which approval or cancellation is selected. FIG. 23A depicts a state in which a user is drawing, and FIG. 23B depicts a state in which a figure is estimated and a candidate figure is drawn. In this case, as depicted in FIG. 23C, “approval” button and “cancellation” button are displayed to be selectable by a user.

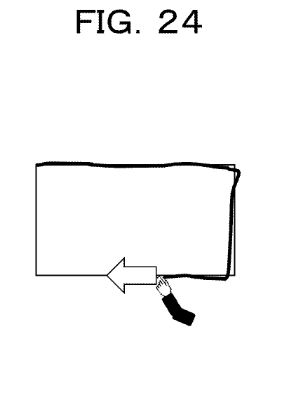

FIG. 24 is an illustration depicting an example in which cancellation is determined based on the speed when drawing is completed. Specifically, the speed of the path at the time of completion of the drawing by a user is calculated, and when the speed exceeds a predetermined value, cancellation is determined.

<Summation>

As described above, according to the present embodiment, it is possible to improve the usability in content display coordination between a client terminal and a display.

A preferred embodiment has been described above. Although specific examples have been depicted and described herein, it is apparent that various modifications and changes may be made on these examples without departing from the broad gist and scope defined in the appended claims. In other words, the details of specific examples and the accompanying drawings should not be construed as limiting the disclosure.

The control device 2 is an example of a content display control device. The terminal management and communication unit 24 is an example of a unit that detects a client terminal. The operation detection unit 22 is an example of a unit that detects a touch operation. The operation detection unit 22 is an example of a unit that estimates a window frame. The correspondence processing unit 23 is an example of a unit that establishes correspondence with a client terminal. The display control unit 21 is an example of a unit that displays content.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control system comprising:
a communication device; and
a display control device configured to communicate with the communication device,
wherein the communication device includes first circuitry configured to:
detect a specific event, and
transmit notification information on the specific event to the display control device, and
wherein the display control device includes second circuitry configured to:
detect drawing processing performed by a user on a screen,
determine a window frame on the screen according to the drawing processing, and
perform control to display a content in the window frame when the notification information is received, the content being designated as a display object by the communication device that has transmitted the notification information.

2. The display control system according to claim 1, wherein the second circuitry displays the content designated as the display object by the communication device in the window frame when detection of the drawing processing and reception of the notification information occur within a predetermined time.

3. The display control system according to claim 1, wherein the second circuitry performs control to display another content designated as the display object by another communication device in the window frame when another notification information rather than the notification information is received from the another communication device.

4. A display control method executed by circuitry, the display control method comprising:
detecting a communication device that designates a content as a display object;
detecting a touch operation of a user on a screen;
setting a window frame on the screen based on a path of the touch operation;
associating the window frame with the communication device based on a user operation to the communication device; and
displaying the content designated by the communication device in the window frame.

5. The display control method according to claim 4, further comprising:
displaying a closed figure at a start position of dragging on the screen when the dragging is started by the touch operation; and
setting the window frame when the dragging by the touch operation is completed in the closed figure without being interrupted.

6. The display control method according to claim 5, further comprising:
obtaining a number of angles or sides from the path of the touch operation; and
identifying the user based on the number of angles or sides obtained.

7. The display control method according to claim 5, further comprising:
staying on stand-by for a predetermined time when the dragging by the touch operation is completed in the closed figure without being interrupted;
checking presence of a signature after the staying on stand-by and obtaining a path of the signature when the signature is present; and
identifying the user based on the obtained path of the signature.

8. The display control method according to claim 5, further comprising:
evaluating a possibility of being recognized as a predetermined figure during a period from a start of the dragging until a path is completed in the closed figure; and
adjusting a size of the closed figure based on the evaluating.

9. The display control method according to claim 5, further comprising:
evaluating a path of the dragging continuously during a period from a start of the dragging until the dragging is completed in the closed figure, and adjusting a size of the closed figure according to a distance to the closed figure when a forward direction of the path is toward the closed figure.

10. The display control method according to claim 5, further comprising:
counting a number of angles in a figure drawn by the path during a period from a start of the dragging until the dragging is completed in the closed figure, and adjusting a size of the closed figure according to the number of the angles.

11. The display control method according to claim 4, further comprising:
estimating a provisional window frame based on the touch operation;
displaying the provisional window frame; and
determining the provisional window frame to be the window frame by a determination operation of a user.

12. The display control method according to claim 11, further comprising:
continuing to estimate the provisional window frame until the determination operation is performed.

13. The display control method according to claim 11, further comprising:
erasing the provisional window frame when a position at which the dragging is completed is in a cancellation area.

14. The display control method according to claim 11, further comprising:
erasing the provisional window frame when a position at which the dragging crosses is away from a start position of the dragging.

15. The display control method according to claim 11, further comprising:
displaying an option of approval or an option of cancellation when the dragging is completed;
setting the provisional window frame to a window frame when the option of approval is selected; and
erasing the provisional window frame when the option of cancellation is selected.

16. The display control method according to claim 11, further comprising:
erasing the provisional window frame when a speed of the dragging is greater than a predetermined value.

17. A display control device comprising:
a memory; and
a processor coupled to the memory and configured to:
detect a communication device that designates a content as a display object,
detect a touch operation of a user on a screen,
set a window frame on the screen based on a path of the touch operation,
associate the window frame with the communication device based on a user operation to the communication device, and
display the content designated by the communication device in the window frame.
